(19) United States
(12) Patent Application Publication
(10) Pub. No.: US 2024/0092100 A1
(43) Pub. Date: Mar. 21, 2024

(54) PRINTING APPARATUS

(71) Applicant: BROTHER KOGYO KABUSHIKI KAISHA, Nagoya (JP)

(72) Inventors: Yasuo NISHIKAWA, Nagoya (JP); Hiroaki TAKAHASHI, Nagoya (JP); Kosuke INUZUKA, Nagoya (JP); Yoshimitsu TANIGUCHI, Tajimi (JP)

(21) Appl. No.: 18/465,585

(22) Filed: Sep. 12, 2023

(30) Foreign Application Priority Data
Sep. 16, 2022 (JP) 2022-148184

(51) Int. Cl. B41J 13/02; B41J 11/00; B41J 13/00

(52) U.S. Cl. CPC B41J 13/02; B41J 11/0015; B41J 13/0018; B41J 13/0027; B41J 13/0036

(57) ABSTRACT

There is provided a printing apparatus including: a housing including a wall with an opening; a mounting section configured to allow a cartridge to be mounted through the opening; a head with a nozzle to eject a liquid; a processing unit including a processing section configured to process a print medium; and a head carriage holding the mounting section and the head. The processing unit is located upstream of the head carriage in a conveyance direction of the print medium, the conveyance direction being a direction in which the print medium passes through a support facing the head.

### REFERENCE TO RELATED APPLICATIONS

This application claims priority from Japanese Patent Application No. 2022-148184 filed on Sep. 16, 2022. The entire content of the priority application is incorporated herein by reference.

### BACKGROUND ART

There are known on-carriage inkjet printers in which an ink cartridge and a head are mounted on the carriage. For example, in a known inkjet printer, a cutter unit is installed downstream of the ink cartridge in a conveyance direction of the paper. The cutter unit is used to cut the paper.

In the inkjet printer described above, a user replaces the ink cartridge from the front of the inkjet printer. In this case, the user's hand may come into contact with the cutter unit, or the ink cartridge may come into contact with the cutter unit.

### DESCRIPTION

The present disclosure is made to solve the above-mentioned problems. The purpose of the present disclosure is to provide a technique for preventing the user's hand from contacting the cutter unit or the cartridge from contacting the cutter unit when the user is replacing the cartridge.

According to an aspect of the present disclosure, there is provided a printing apparatus including a housing, a mounting section, a head, a processing unit and a head carriage. The housing includes a wall with an opening. The mounting section is configured to allow a cartridge to be mounted through the opening. The head includes a nozzle to eject a liquid. The processing unit includes a processing section configured to process a print medium. The head carriage is configured to hold the mounting section and the head. The processing unit is located upstream of the head carriage in a conveyance direction of the print medium. The conveyance direction is a direction in which the print medium passes while facing the head.

According to the above configuration, the processing unit is located upstream of the head carriage in the conveyance direction, rather than the head carriage, so that when the user replaces the cartridge from the opening, the user's hand is prevented from coming into contact with the processing unit, or the cartridge from coming into contact with the processing unit.

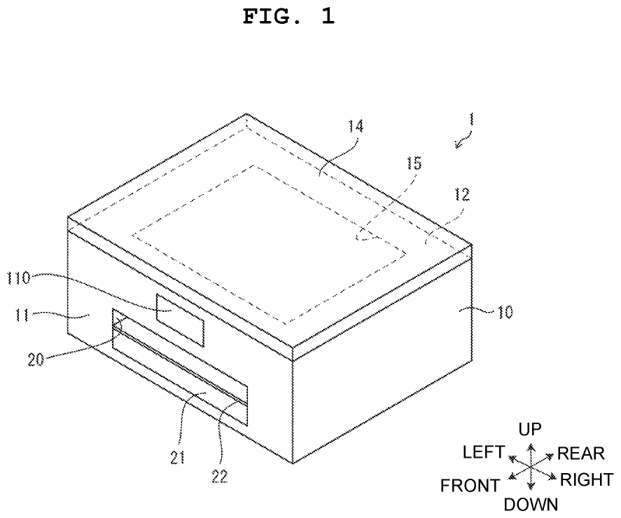

FIG. 1 depicts a diagram of the exterior of the printing apparatus.

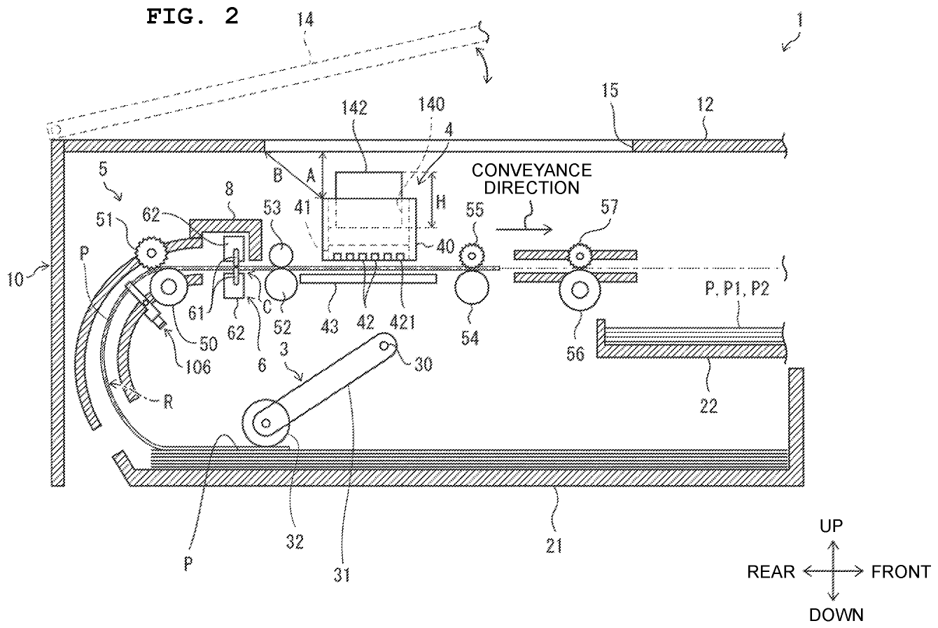

FIG. 2 depicts a cross-sectional view of the internal structure of the printing apparatus.

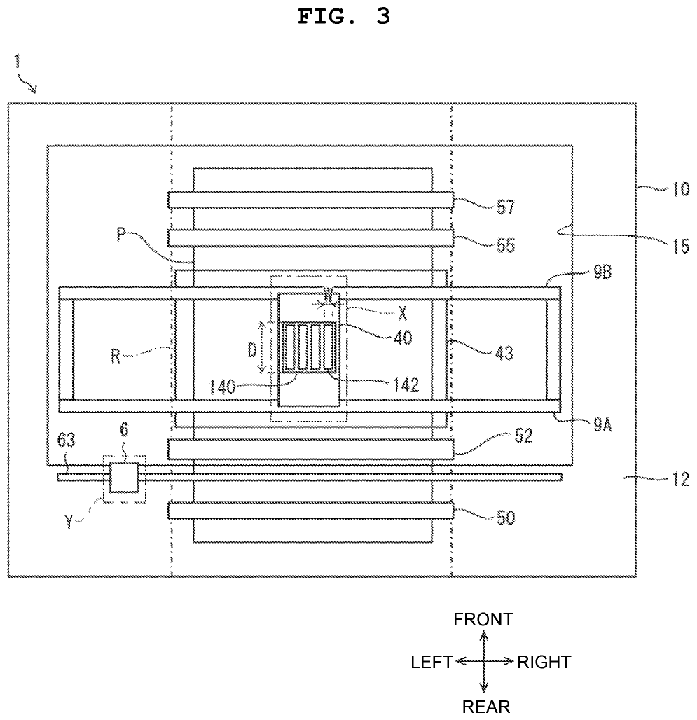

FIG. 3 depicts a top view of the internal structure of the printing apparatus.

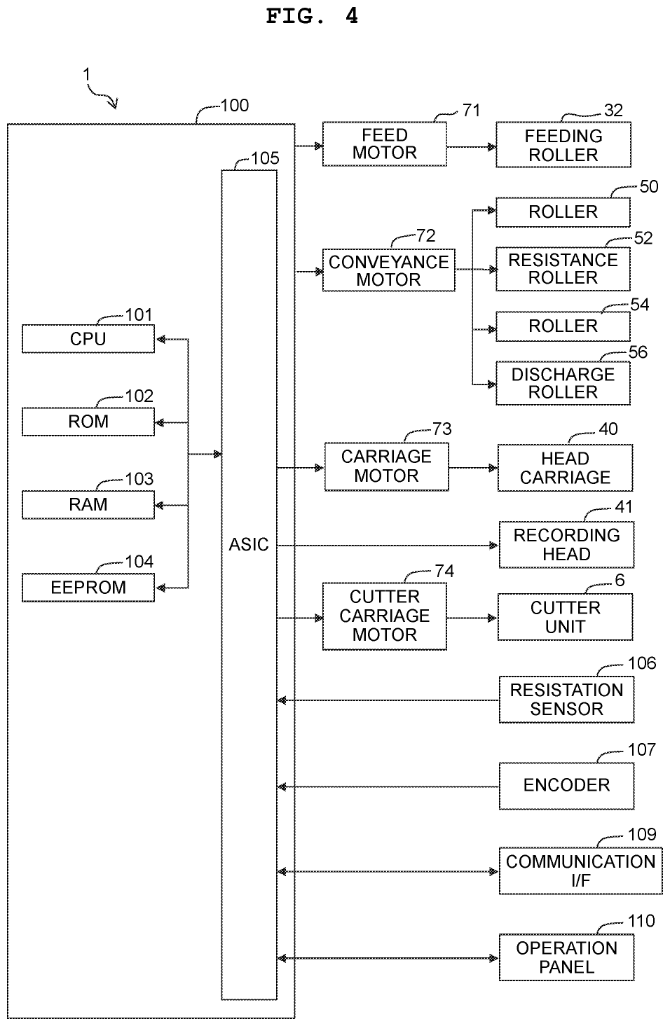

FIG. 4 depicts a block diagram indicating the electrical configuration of the printing apparatus.

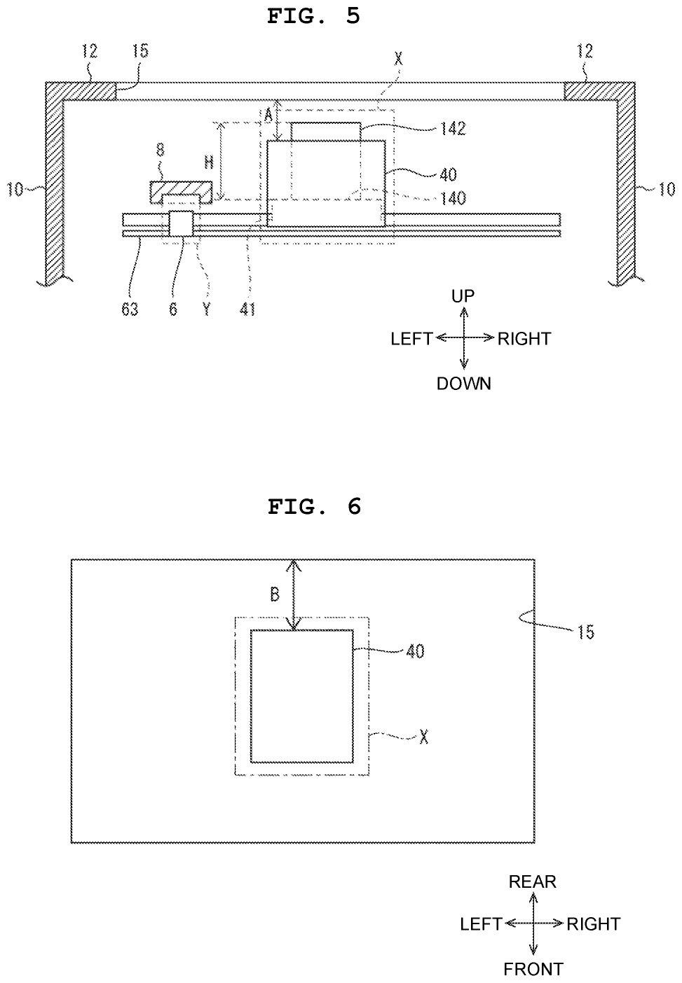

FIG. 5 depicts a front view of the internal configuration of the printing apparatus with the cover opened.

FIG. 6 depicts a schematic top view indicating a positional relationship between the head carriage at the replacement position of FIG. 5 and the opening in the housing.

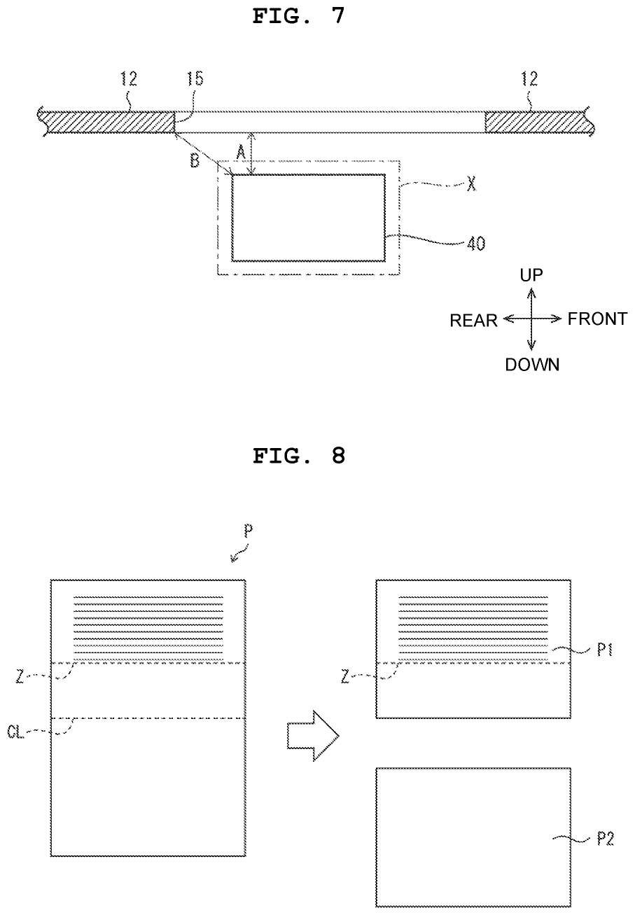

FIG. 7 depicts a side-view indicating a positional relationship between the head carriage at the replacement position of FIG. 5 and the opening of the housing.

FIG. 8 depicts the sheet before cutting and the first and second sheets after cutting.

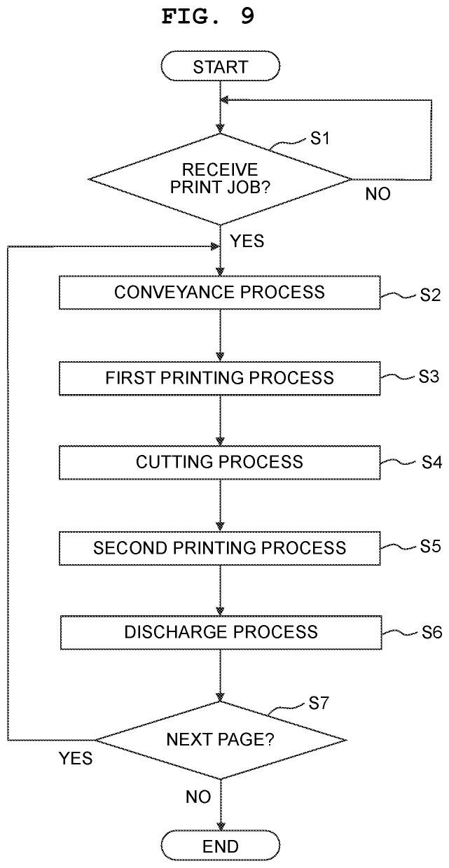

FIG. 9 depicts a flowchart indicating a flow of control during printing by the controller of the printing apparatus.

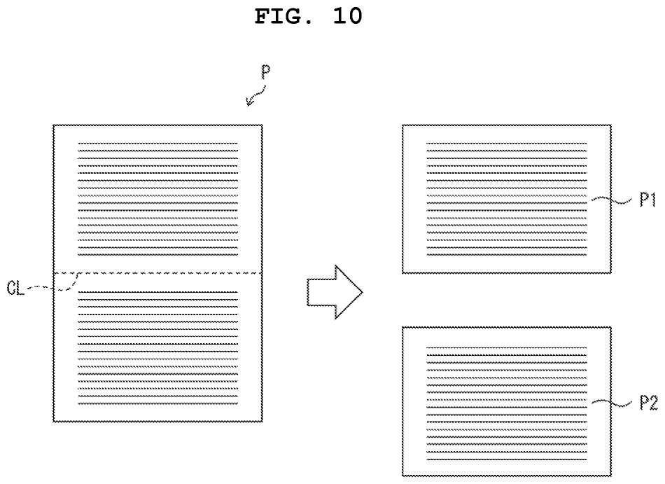

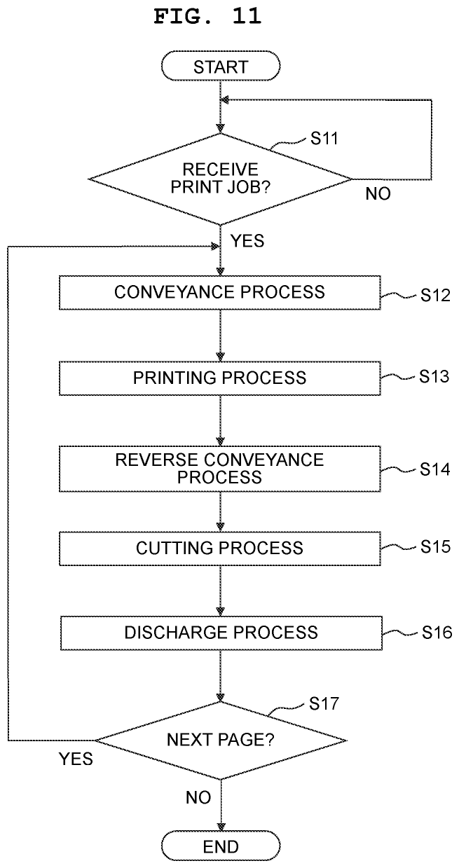

FIG. 10 depicts the sheet before cutting and the first and second sheets after cutting.

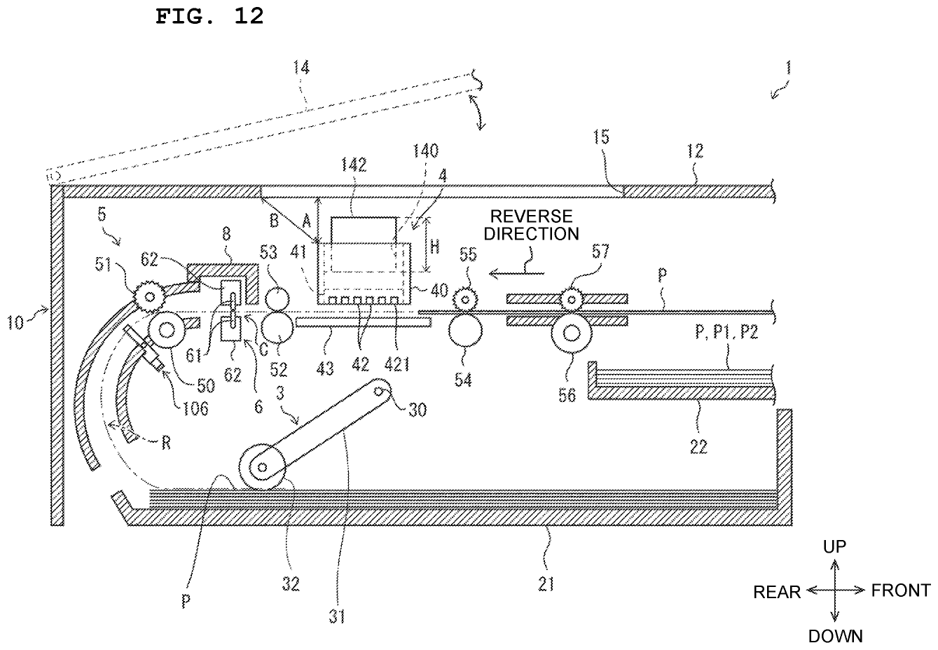

FIG. 11 depicts a flowchart indicating the flow of control during printing by the controller of the printing apparatus.

FIG. 12 depicts a cross-sectional view indicating the position of the sheet during the reverse transfer process by the controller of the printing apparatus.

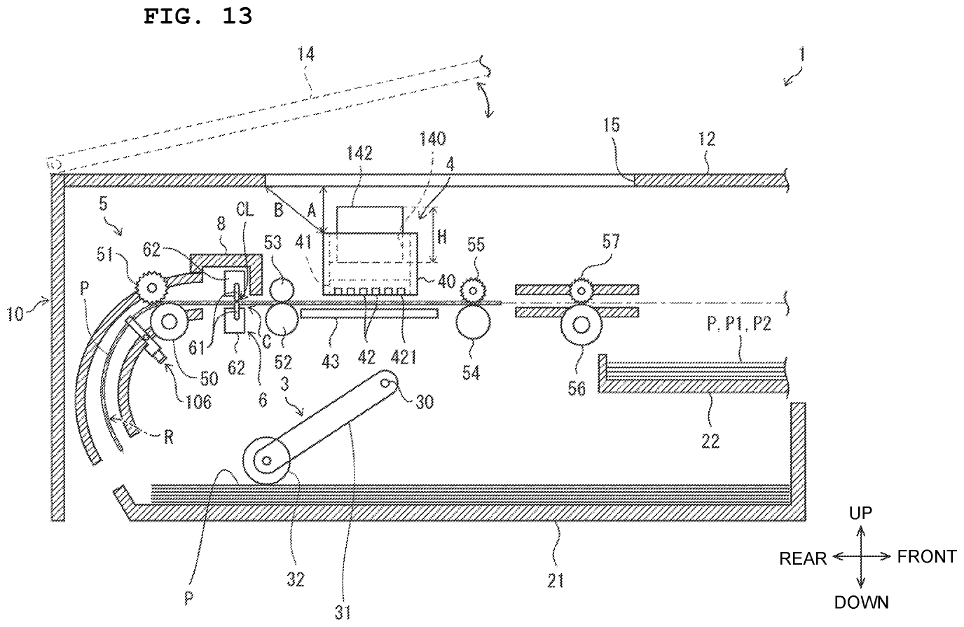

FIG. 13 depicts a cross-sectional view indicating a position of the sheet during the cutting and feeding process by the controller of the printing apparatus.

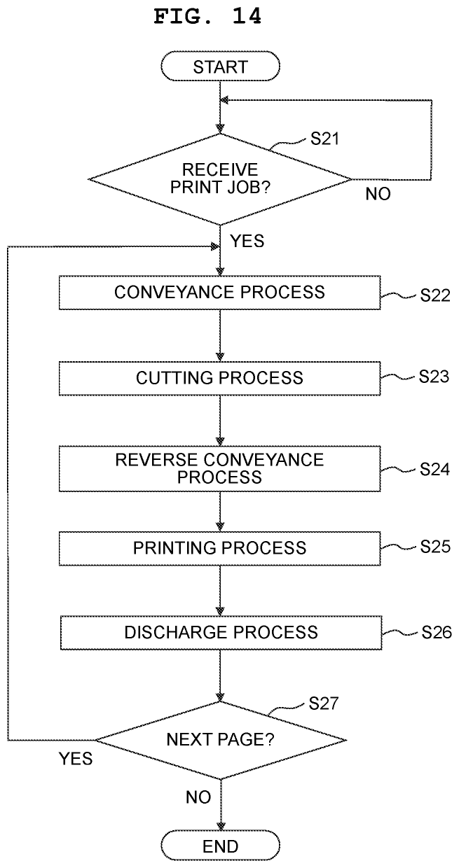

FIG. 14 depicts a flowchart indicating the flow of control during printing by the controller of the printing apparatus.

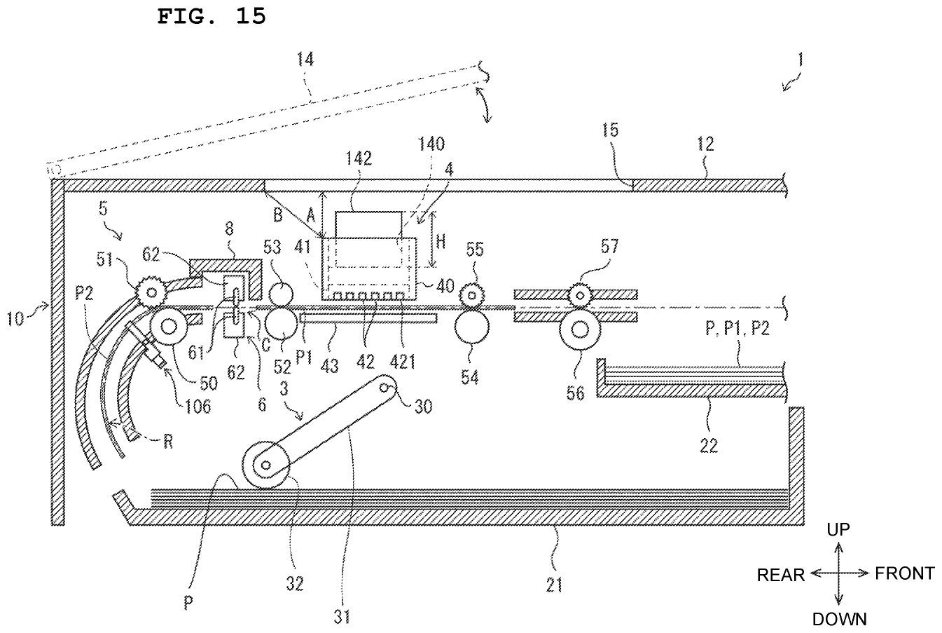

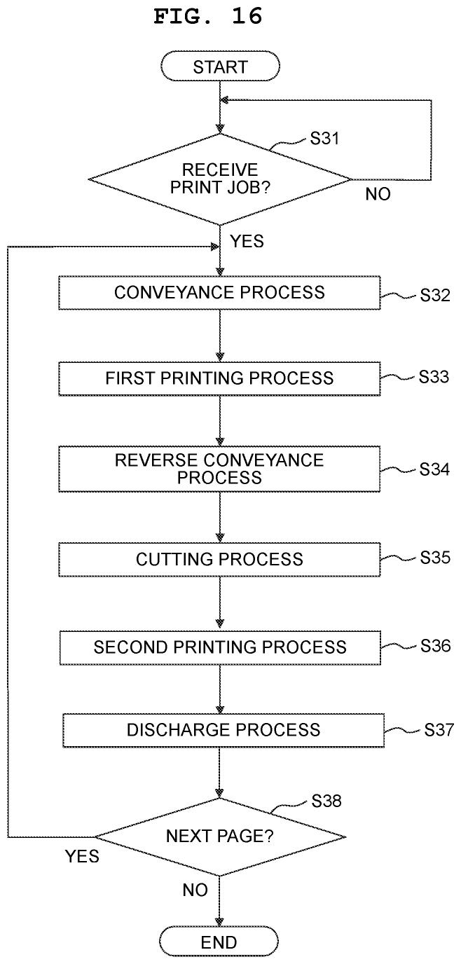

FIG. 15 depicts a cross-sectional view indicating the positions of the first and second sheets during the printing process by the controller of the printing apparatus.

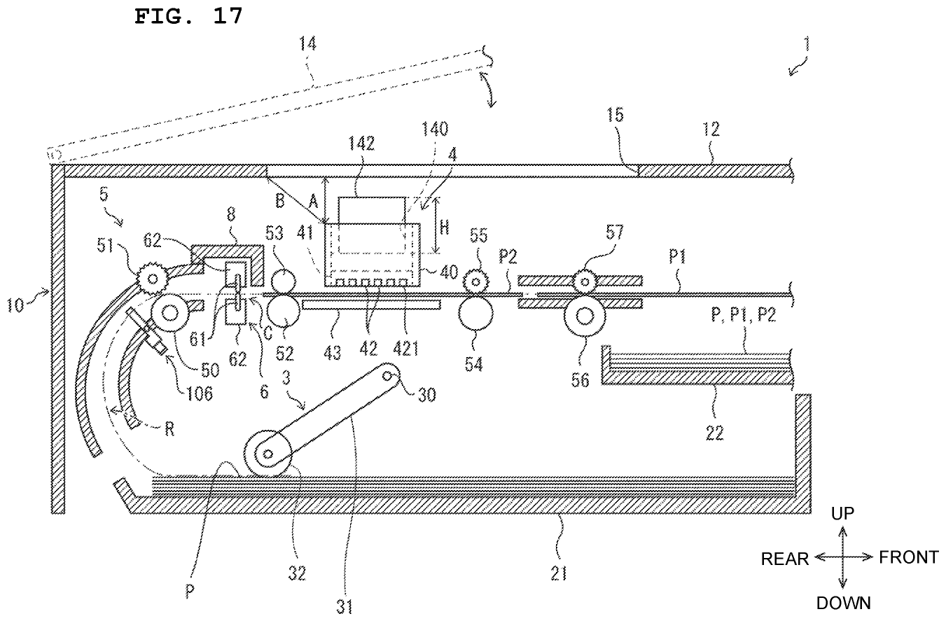

FIG. 16 depicts a flowchart indicating the flow of control during printing by the controller of the printing apparatus.

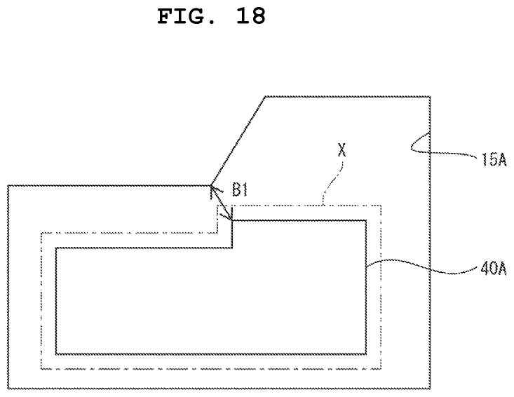

FIG. 17 depicts a cross-sectional view indicating the positions of the first and second sheets during the second printing process by the controller of the printing apparatus.

FIG. 18 depicts a top view indicating a positional relationship between the head carriage at the replacement position and the opening in the housing.

### FIRST EMBODIMENT

<Configuration of Printing Apparatus>

The printing apparatus 1 in the first embodiment of the present disclosure is described below with reference to FIGS. 1 to 9. The printing apparatus 1 depicted in FIG. 1 is an MFP (Multi-Function Peripheral) equipped with multiple functions such as printing, scanning, copying, and faxing. For convenience of explanation, the up-down direction, left-right direction, and front-rear direction of the printing apparatus 1 are defined as indicated by the arrows in FIG. 1.

The printing apparatus 1 has an inkjet printing function. The printing apparatus 1 prints print data specified by a print job on a sheet P, for example, by ejecting ink. The printing apparatus 1 may be capable of color printing or may be dedicated to monochrome printing. Sheet P is an example of a print medium, for example, A4 size plain paper. Thick paper and thin paper, etc. may be used as the print medium.

As depicted in FIG. 1, the printing apparatus 1 includes a housing 10, a feed tray 21, a discharge tray 22, an operation panel 110, and a cover 14. The housing 10 has an abbreviated rectangular solid shape.

An opening 20 is formed in the front wall 11 of the housing 10. The feed tray 21 and the discharge tray 22 are arranged in the opening 20 in a removable way. The feed tray 21 has an open upper surface and accommodates a plurality of sheets P. The feed tray 21 is inserted or removed in the front-rear direction of the printing apparatus 1.

The discharge tray 22 is located above the feed tray 21. The discharge tray 22 is an example of a discharge section, and the sheet P, the first sheet P1, and the second sheet P2, on which images are printed, are discharged to the discharge tray 22. The sheets P, etc. are discharged in the front-rear direction of the printing apparatus 1.

In the printing apparatus 1, the operation panel 110 is located on the front wall 11 of the housing 10. The operation panel 110 is, for example, a touch panel. The operation panel 110 can be used to make various settings related to printing of the printing apparatus 1 through touch operation by the user. The operation panel 110 accepts, for example, the setting of whether or not to cut the sheet P. The information set by the operation panel 110 is output to the controller 100 (see FIG. 4).

As also depicted in FIG. 2, a cover 14 is provided on an upper wall 12 of the housing 10. The cover 14 is an example of an opening/closing portion. The cover 14 is movable between a first position that covers the opening 15 and a second position that opens the opening 15. In FIG. 2, the part of the discharge tray 22 that has been drawn out to be extended is omitted.

When the user moves the cover 14 to the second position to open the opening 15, the opening 15 is exposed from the housing 10. This allows the user to access the interior of the printing apparatus 1. Specifically, the cartridge 142 (see FIG. 3) is exposed and the user can replace the cartridge 142.

The printing apparatus 1 may have a scanner housing between the housing 10 and the cover 14. Inside the scanner housing is a scanner that reads the image printed on the sheet P.

As depicted in FIG. 2, the printing apparatus 1 further includes a feeding section 3, a printer section 4, a conveyor 5, and a cutter unit 6. The feeding section 3 has a shaft 30, a feeding arm 31, and a feeding roller 32.

The feeding roller 32 is rotatably supported at the end of the feeding arm 31. The feeding arm 31 is rotatably supported by the shaft 30 supported on the frame of the printing apparatus 1. The feeding arm 31 is urged or biased toward the feed tray 21 by its own weight or by elastic force from a spring or the like.

The feeding roller 32 is rotated by the driving force of the feeding motor (see FIG. 4). When the feeding roller 32 rotates, the sheet P stored in the feed tray 21 is conveyed to the conveyance route R. The conveyance route R extends upward from the rear end of the feed tray 21, curves forward at the rear side of the housing 10, passes through the position of the printer section 4, and reaches the discharge tray 22.

A registration sensor 106 is located upstream of the roller 50 in the conveyance route R. The registration sensor 106 is a sensor for detecting when a sheet P has come into contact with the registration sensor 106. As the registration sensor 106, a sensor having an actuator that oscillates when the sheet P contacts it, an optical sensor, or the like can be used.

The registration sensor 106 outputs an ON signal when the sheet P is in contact with the sensor and an OFF signal when the sheet P is not in contact with the sensor. The detection signal by the registration sensor 106 is output to the controller 100.

The conveyor 5 includes a roller 50, a resistance roller 52, a roller 54, and a discharge roller 56. The roller 50 is located between the registration sensor 106 and the cutter unit 6 in the conveyance route R. A spur roller 51 is located opposite an upper part of the roller 50. The roller 50 is driven by the conveyance motor 72 (see FIG. 4). The spur roller 51 rotates as the roller 50 rotates.

When the roller 50 and the spur roller 51 rotate forward, the sheet P, the first sheet P1, or the second sheet P2 is conveyed toward the cutter unit 6. On the other hand, when the roller 50 and the spur roller 51 rotate in reverse, the sheet P, the first sheet P1, or the second sheet P2 is conveyed toward the feed tray 21.

The resistance roller 52 is located upstream of the printer section 4 in the conveyance direction of the sheet P in the conveyance route R. The resistance roller 52 is driven by the conveyance motor 72 (see FIG. 4). A pinch roller 53 is located opposite an upper part of the resistance roller 52. The pinch roller 53 rotates with the rotation of the resistance roller 52.

When the resistance rollers 52 and the pinch rollers 53 rotate forward, the sheet P, the first sheet P1 and the second sheet P2 are conveyed toward the printer section 4. On the other hand, when the resistance rollers 52 and pinch rollers 53 rotate in reverse, the sheet P, the first sheet P1, and the second sheet P2 are conveyed to the cutter unit 6.

The resistance roller 52 is provided with an encoder 107 (see FIG. 4) that detects the rotation of the resistance roller 52. The encoder 107 outputs pulse signals to the controller 100 in response to the rotation of the resistance roller 52.

The cutter unit 6 is located upstream of the head carriage 40 and the resistance roller 52 in the conveyance direction of the sheet P in the conveyance route R. That is, the resistance roller 52 is located between the head carriage 40 and the cutter unit 6 in the conveyance direction. The resistance roller 52 is an example of a conveyance roller that conveys the sheet P. The conveyance direction is the direction in which the sheet P passing through the platen 43 is conveyed during the printing process.

The cutter unit 6 is an example of a processing unit that processes the sheet P. The cutter unit 6 has a blade 61, which is an example of the processing unit, and a cutter carriage 62 that supports the blade 61. The blade 61 includes a pair of round blades. The pair of circular blades face each other vertically. The pair of blades 61 are supported by the cutter carriage 62, which is movable in the left-right direction.

The cutter carriage 62 is supported on a rail 63 extending in the left-right direction. The cutter carriage 62 moves along the rail 63 under the driving force of the cutter carriage motor 74 (see FIG. 4) to move the blade 61 in the left-right direction (see FIG. 3). The cutter unit 6 cuts the sheet P in the width direction by moving the cutter carriage 62, which supports the blade 61, in the left-right direction.

One of the pair of blades 61 may be a fixed blade and the other a round blade. In this case, the fixed blade extends in the left-right direction and is fixed to the housing 10. The round blade is supported by a cutter carriage that can move in the left-right direction. The pair of blades 61 may be fixed blades extending in the left-right direction. In this case, the upper fixed blade and the lower fixed blade are in contact with each other to cut the sheet P in the width direction.

The processing unit is not limited to the cutter unit 6 that cuts the sheet P. For example, the printing apparatus 1 may include a processing unit that performs creasing of the sheet P instead of the cutter unit 6. Alternatively, the printing apparatus 1 may be equipped with a processing unit that perforates the sheet P. When the printing apparatus 1 is equipped with these processing units, the processing unit has a processing section for creasing the sheet P or for perforating the sheet P.

A shield 8 is located above the cutter unit 6. The shield 8 is attached to a guide member that defines the conveyance path R, which can be opened and closed. When the cover 14 is in the second position and the opening 15 is open, the shield 8 shields the upper and front part of the cutter unit 6 from the outside of the housing 10. When the cutter unit 6 is replaced, the shield 8 is opened. The shield 8 may be omitted.

The printer section 4 is located above the feeding section 3. The printer section 4 has a head carriage 40, a recording head 41, which is an example of a liquid discharge head, a plurality of nozzles 42, and a platen 43. The head carriage 40 is supported by the guide rails 9A and 9B extending in the left-right direction (see FIG. 3).

The head carriage 40 is transmitted the driving force of the carriage motor 73 and moves in the scanning direction reciprocally, which is orthogonal to the conveyance direction. The scanning direction corresponds to the left-right direction of the printing apparatus 1. When printing on the sheet P, the controller 100 (see FIG. 4) repeats the recording process, in which an image for one line is recorded on the sheet P, and the conveyance process, in which sheet P is conveyed by a predetermined line feed amount. In the recording process, the controller 100 ejects ink from the nozzles 42 of the recording head 41 while moving the head carriage 40 in the width direction of the sheet P while the sheet P is stopped. This causes one line of images to be recorded on the sheet P. In the conveyance process, the controller 100 drives the roller 50, the resistance roller 52, the roller 54, and the discharge roller 56 to convey the sheet P by a predetermined line feed amount.

The head carriage 40 is equipped with the recording head 41. Four nozzle rows aligned in the left-right direction are formed on a lower surface (a nozzle surface 421) of the recording head 41. Each nozzle row has a plurality of nozzles 42 aligned in the front-rear direction. The four inks (black, yellow, cyan, and magenta inks) are ejected from the four nozzle rows respectively. The four nozzle rows corresponding to the four inks are arranged in this order from right to left. The order in which the nozzle rows are arranged is not limited to this and can be changed as needed.

The head carriage 40 has a mounting section 140 where the cartridge 142 is removably mounted. The printing apparatus 1 is a so-called on-carriage type printing apparatus in which the recording head 41 and the cartridge 142 are held in the head carriage 40. The cartridge 142 may be integrated with the recording head 41 or may be separate and separable from the recording head 41.

In the mounting section 140, the entirety of the cartridge 142 is positioned above the recording head 41. In the mounting section 140, a portion of the cartridge 142 may be positioned above the recording head 41 and the remaining portion of the cartridge 142 may be positioned below the recording head 41.

The recording head 41 ejects ink contained in the cartridge 142 through the nozzles 42. The ink is an example of a liquid. For example, the inks may be black, yellow, cyan, and magenta inks. The ink may be only the black ink.

The cartridges 142 are explained below with reference to FIG. 3. As depicted in FIG. 3, the four cartridges 142 are mounted on the mounting section 140 in a row in the left-right direction. The cartridges 142 contain ink to be supplied to the recording head 41. In FIG. 3, the shield 8 is omitted.

The ink stored in each of the 142 cartridges is supplied to the recording head 41 via tubes not depicted. The recording head 41 ejects ink droplets from the nozzles 42 by vibrating a vibrating element such as a piezoelectric element.

The platen 43 is located opposite to and below the recording head 41 and extends over the entire length of the sheet Pin the left-right direction. The platen 43 is an example of a support section and supports the sheet P from below during the recording process. Printing on the sheet P is performed by the recording head 41 selectively ejecting ink drops in the process of the head carriage 40 moving against the sheet P supported by the platen 43.

As depicted in FIG. 2, the roller 54 is located in the conveyance route R. The roller 54 is located downstream of the printer section 4 in the conveyance direction of the sheet P. The spur roller 55 is opposite an upper part of the roller 54. The roller 54 is driven by the conveyance motor 72 (see FIG. 4). The spur roller 55 rotates with the rotation of the roller 54.

When the roller 54 and the spur roller 55 rotate forward, the sheet P, the first sheet P1, or the second sheet P2 is conveyed toward the discharge roller 56. On the other hand, when the roller 54 and the spur roller 55 rotate in reverse, the sheet P, the first sheet P1, or the second sheet P2 is conveyed toward the printer section 4.

The discharge roller 56 is located in the conveyance route R. The discharge roller 56 is located downstream of the roller 54 in the conveyance direction of the sheet P. The spur roller 57 is opposite an upper part of the discharge roller 56. The discharge roller 56 is driven by the conveyance motor 72 (see FIG. 4). The spur roller 57 rotates with the rotation of the discharge roller 56. When the discharge roller 56 and the spur roller 57 rotate positively, the sheet P, the first sheet P1, and the second sheet P2 are discharged to the discharge tray 22. On the other hand, when the discharge roller 56 and the spur roller 57 rotate in reverse, the sheet P, the first sheet P1, or the second sheet P2 is conveyed toward the printer section 4.

<Electrical Configuration of Printing Apparatus>

As depicted in FIG. 4, the printing apparatus 1 includes a controller 100 and a communication interface (I/F) 109.

The controller 100 includes a CPU (Central Processing Unit) 101, ROM (Read Only Memory) 102, RAM (Random Access Memory) 103, EEPROM 104 (registered trademark), and ASIC 105, which are connected by an internal bus.

The ROM 102 stores programs, etc., for the CPU 101 to control various operations. The RAM 103 is used as a storage area for temporarily recording data, signals, etc., used when CPU 101 executes the above programs, or as a work area for data processing. The EEPROM 104 stores information that should be retained after power off is stored.

The controller 100 controls the feed motor 71, the conveyance motor 72, the carriage motor 73, the recording head 41, the cutter carriage motor 74, and the operation panel 110, etc. based on a control program read from the ROM 102.

The ASIC 105 is connected to the feed motor 71, the conveyance motor 72, the carriage motor 73, the recording head 41, the cutter carriage motor 74, the registration sensor 106, the encoder 107, the communication I/F 109, and the operation panel 110.

The ASIC 105 supplies drive current to the feed motor 71, the conveyance motor 72, the carriage motor 73, and the cutter carriage motor 74. The feed motor 71, the conveyance motor 72, the carriage motor 73, and the cutter carriage motor 74 are DC motors. In the DC motors, the higher the drive current supplied, the faster the rotation speed of the DC motors, and the lower the drive current supplied, the slower the rotation speed. The controller 100 controls the rotation of the feed motor 71, the conveyance motor 72, the carriage motor 73, and the cutter carriage motor 74, for example, by PWM (Pulse Width Modulation) control.

The controller 100 applies a drive voltage to the vibrating element of the recording head 41 to eject ink drops from the nozzles 42. The controller 100 detects the amount of rotation of the resistance roller 52 based on the pulse signal output from the encoder 107. The controller 100 detects that the sheet P has passed the position of contact with the resistance roller 52 based on the detection signal output from the registration sensor 106. Then, the controller 100 estimates the amount of sheet P conveyed in the conveyance route R based on the pulse signal output from the encoder 107 after the ON signal is output from the registration sensor 106.

The communication I/F 109 is connected to a network such as a LAN and enables connection to an external device such as a PC in which a driver for the printing apparatus 1 is embedded. When the printing apparatus 1 receives a print job via the communication I/F 109, the printing apparatus 1 prints the print data specified by the print job on the sheet P by controlling various parts of the printing apparatus 1.

<Replacement of the Cartridge>

Next, the replacement of the 142 cartridges is explained with reference to FIG. 5.

When the user replaces the cartridge 142, the head carriage 40 of the printer section 4 is moved by the controller 100 to the replacement position X depicted in FIG. 5. The head carriage 40 is thereby located in the housing 10 with the head carriage 40 exposed through the opening 15. The replacement position X is located near the center of the left-right direction in the guide rails 9A and 9B depicted in FIG. 3.

The user removes the cartridge 142 from the mounting section 140 of the head carriage 40 in the replacement position X to replace the cartridge 142. Specifically, the user opens the cover 14 and replaces the cartridge 142 through the opening 15 of the housing 10 (see FIG. 2).

As depicted in FIG. 5, when the cartridge 142 is installed or removed, the cutter unit 6 is located at the standby position Y, which is displaced in the scanning direction (the left-right direction) relative to the replacement position X of the cartridge 142. Specifically, the standby position Y of the cutter unit 6 is located to the left of the platen 43. The standby position Y may be located to the right of the platen 43.

The shield 8 covers the top of the cutter unit 6. Therefore, the cutter unit 6 is located in the housing 10 without being exposed through the opening 15. This prevents the user's hands from coming into contact with the cutter unit 6.

<Positional Relationship Between the Opening in the Housing and the Head Carriage>

Next, the positional relationship between the opening 15 of the housing 10 and the head carriage 40 will be explained with reference to FIGS. 5 to 7. In the printing apparatus 1 of the first embodiment, the gap between the opening 15 of the housing 10 and the head carriage 40 is adjusted as depicted below. This prevents the user's hand from entering toward the cutter unit 6 when replacing the cartridge 142.

Here, for example, a length D which is a length of the cartridge 142 in the front-rear direction is longer than a length H which is a length of the cartridge 142 in the up-down direction. Furthermore, the length H of the cartridge 142 in the up-down direction is longer than a width W of the cartridge 142 in a width direction.

As depicted in FIGS. 2 and 5, the length A is defined to be the length in the up-down direction between the wall of the housing 10 with the opening 15 and the upper-end of the head carriage 40. The length H is defined to be the length in the up-down direction of the cartridge 142 mounted in the mounting section 140. The length A is shorter than the length H.

The length D is defined as a length of the cartridge 142 in the front-rear direction mounted in the mounting section 140 depicted in FIG. 3. The length A is shorter than the length D. The length A should be at least shorter than the length D.

As depicted in FIGS. 2 and 5 to 7, the length B is defined as the length between the end of the opening 15 on the rear side of housing 10 and the upper-end of the rear side of head carriage 40 that is closest to the end of the opening 15 when head carriage 40 is in the replacement position X. The length B is shorter than the length H.

In this way, it is difficult to get the cartridge 142 into the gap between the wall surface where the opening 15 is formed in housing 10 and the upper-end of the head carriage 40. This prevents the cartridge 142 from coming into contact with the cutter unit 6 when the cartridge 142 is replaced.

<Flow of Control by the Controller>

Next, the flow of control during printing by the controller 100 of the printing apparatus 1 of the first embodiment will be explained with reference to FIGS. 8 and 9. In the printing apparatus 1 of the first embodiment, as depicted in FIG. 8, the sheet P is cut by the cutter unit 6 in the middle of printing on the sheet P. The user sets whether or not to cut the sheet P by operating the PC or the operation panel 110.

As depicted in FIG. 9, the controller 100 determines whether a print job is received via the communication I/F 109 (S1). The controller 100 repeats the process S1 until a print job is received (S1: NO), and when a print job is received (S1: YES), the conveyance process is executed (S2).

In process S2, the controller 100 drives the feed motor 71 to rotate the feeding roller 32 to convey the sheet P from the feed tray 21 to the conveyance route R. Then, the controller 100 drives the conveyance motor 72 forward when the front end of the sheet P conveyed in the conveyance route R reaches the registration sensor 106. As a result, the roller 50, the resistance roller 52, the roller 54, and the discharge roller 56 rotate forward to convey the sheet P to the printer section 4, as depicted in FIG. 2.

The controller 100 executes the first printing process (S3). In process S3, the controller 100 controls the printer section 4 to print an image based on the print data from the front end of the sheet P to a predetermined position Z in the conveyance direction (see FIG. 8).

After processing S3, the controller 100 controls the cutter unit 6 to cut the sheet P on which the image has been printed up to the predetermined position Z. Thereby, the controller 100 executes the cutting process to generate the first sheet P1 and the second sheet P2 (S4).

In process S4, the controller 100 drives the cutter carriage motor 74 to move the cutter carriage 62 in the scanning direction. As a result, the sheet P is cut at the center position CL, which is the center position of the sheet P in the width direction. The first sheet P1 is an example of the first print medium. The second sheet P2 is an example of the second print medium. The cutting process is an example of a processing process. The center position CL is an example of a first position.

After processing S4, the controller 100 executes the second printing process (S5). In process S5, the controller 100 controls the printer section 4 to print an image from the predetermined position Z to the rear edge of the first sheet P and also prints an image on the second sheet P.

After processing S5, the controller 100 executes the discharge process (S6). In process S6, the controller 100 rotates the roller 50, the resistance roller 52, the roller 54, and the discharge roller 56 forward. As a result, the first sheet P1 and the second sheet P2 with printed images are conveyed to the discharge tray 22.

After processing S6, the controller 100 determines whether a next page exists or not (S7). If the next page exists in the print job (S7: YES), the controller 100 returns to process S2 and performs the conveyance process. On the other hand, if the next page does not exist in the print job (S7: NO), the flow depicted in FIG. 9 is terminated.

In the printing apparatus 1 of the first embodiment described above, as depicted in FIG. 2, the cutter unit 6 is located upstream of the head carriage 40 of the printer section 4 in the conveyance direction in the conveyance route R, that is, at the rear side of the printing apparatus 1. Furthermore, the cutter unit 6 is located rearward of the resistance roller 52. This prevents the user's hand from contacting the cutter unit 6 and the cartridge 142 from contacting the cutter unit 6 when the user replaces the cartridge 142 through the opening 15 of the housing 10.

Since an opening 15 is formed in the upper wall 12 of the housing 10, the user can easily replace the cartridge 142 through the opening 15 by opening the cover 14. Furthermore, the shield 8 is located above the cutter unit 6 to shield the upper and front part of the cutter unit 6 from the outside of the housing 10, so that the user's hands are prevented from directly contacting the cutter unit 6. Thus, the user can safely replace the cartridge 142.

As depicted in FIG. 5, the replacement position X of the head carriage 40 and the standby position Y of the cutter unit 6 are offset in the scanning direction, i.e., left-right direction. This prevents the user's hand from contacting the cutter unit 6 and the cartridge 142 from contacting the cutter unit 6 when attaching and removing the cartridge 142. Thus, the user can smoothly replace the cartridge 142.

The controller 100 performs the cutting process (S4) before printing on the sheet P is completed. This allows the first printing process (S3) and second printing process (S5) to be executed without having the sheet P conveyed in the opposite direction of the conveyance direction in a configuration where the cutter unit 6 is upstream in the conveyance direction from the printer section 4. This reduces the processing time by the controller 100.

### SECOND EMBODIMENT

Next, the printing apparatus 1 in the second embodiment of the present disclosure will be described with reference to FIGS. 10 to 13. For convenience of explanation, members that have the same functions as those described in the first embodiment are marked with the same reference numerals, and the description will not be repeated. In the printing apparatus 1 of the second embodiment, the flow of control during printing by the controller 100 is different from that of the first embodiment.

In the second embodiment, the sheet P is cut after printing on the sheet P is completed.

<Flow of Control by the Controller>

As depicted in FIG. 10, when the controller 100 receives a print job via the communication I/F 109 (S11: YES), the controller 100 executes a conveyance process to convey the sheet P to the printer section 4 (S12).

In process S12, the controller 100 conveys the sheet P from the feed tray 21 to the conveyance route R by rotating the feeding roller 32. The controller 100 conveys the sheet P to the printer section 4 by rotating the roller 50, the resistance roller 52, the roller 54, and the discharge roller 56 in the forward direction.

The controller 100 controls the printer section 4 to execute a printing process that prints an image based on the print data on the entire sheet P (S13), as depicted in FIG. 10. After processing S13, the controller 100 executes a reverse conveyance process (S14). In the reverse conveyance process, the sheet P on which the image is printed is conveyed in the reverse direction from the conveyance direction to the cutting position C.

In process S14, the controller 100 drives the conveyance motor 72 in reverse to rotate the roller 50, the resistance roller 52, the roller 54, and the discharge roller 56 in the opposite direction. As depicted in FIG. 12, the sheet P, on which the image has been printed by the printer section 4, is conveyed in the reverse direction from the conveyance direction.

As depicted in FIG. 13, when the center position CL of the sheet P reaches a position where it overlaps the cutting position C, the controller 100 stops the transport of the sheet P. The controller 100 controls the cutter unit 6 to cut the sheet P on which the image is printed. In this way, the controller 100 executes the cutting process to produce the first sheet P1 and the second sheet P2 (S15).

After processing S15, the controller 100 executes the ejection process to convey the first sheet P1 and the second sheet P2 with printed images to the discharge tray 22 (S16). Specifically, the controller 100 rotates the roller 50, the resistance roller 52, the roller 54, and the discharge roller 56 forward. As a result, the first sheet P1 and the second sheet P2 are ejected or discharged to the discharge tray 22.

After processing S16, the controller 100 determines whether a next page exists or not (S17). If the controller 100 determined that the next page exists in the print job (S17: YES), it returns to process S12. If the controller 100 determined that the next page does not exist in the print job (S17: NO), it terminates the flow depicted in FIG. 11.

The printing apparatus 1 of the second embodiment described above also has the same effects as the first embodiment. In particular, in the printing apparatus 1 of the second embodiment, the controller 100 executes the cutting process (S15) after the printing processes (S13) has been completed. This prevents the printed image from being shifted due to the execution of the cutting process during the execution of the printing process.

### THIRD EMBODIMENT

Next, the printing apparatus 1 in the third embodiment of the present disclosure will be described with reference to FIGS. 14 and 15. For convenience of explanation, members that have the same functions as those described in the first embodiment are marked with the same reference numerals, and the description will not be repeated. In the printing apparatus 1 of the third embodiment, the flow of control during printing by the controller 100 is different from that of the first embodiment. In the third embodiment, after cutting the sheet P, printing on the first sheet P1 and the second sheet P2 is performed.

<Flow of Control by the Controller>

As depicted in FIG. 14, when the controller 100 receives a print job via the communication I/F 109 (S21: YES), the controller 100 executes the conveyance process (S22). In the conveyance process, the sheet P is conveyed along the conveyance direction to the cutting position C where the cutter unit 6 is located.

In process S22, the controller 100 controls the feeding roller 32 to convey the sheet P from the feed tray 21 to the conveyance route R. The controller 100 also controls the roller 50, the resistance roller 52, the roller 54, and the discharge roller 56 to convey the sheet P until the center position CL of the sheet P (see FIG. 10) overlaps the cutting position C.

After processing S22, the controller 100 controls the cutter unit 6 to execute a cutting process to generate the first sheet P1 and the second sheet P2 by cutting the center position CL of the sheet P (S23).

After processing S23, the controller 100 reverses the roller 50, the resistance roller 52, the roller 54, and the discharge roller 56. Thereby, the controller 100 executes a reverse conveyance process in which the first sheet P1 and the second sheet P2 are conveyed to the printer section 4 in the reverse direction of the conveyance direction (S24). The cutter unit 6 is located upstream of the printer section 4 in the conveyance direction. This prevents the rear end of the first sheet P1 from interfering with the recording head 41 of the printer section 4, resulting in a jam.

After processing S24, the controller 100 executes a printing process (S25). In the printing process, the controller 100 controls the roller 50, the resistance roller 52, the roller 54, and the discharge roller 56 to convey the sheet P. Furthermore, as depicted in FIG. 15, the controller 100 controls the printer section 4 to print images on the first sheet P1 and the second sheet P2.

After processing S25, the controller 100 executes a discharge process (S26). In the discharge process, the controller 100 rotates the roller 50, the resistance roller 52, the roller 54, and the discharge roller 56 forward. As a result, the first sheet P1 and the second sheet P2 with printed images are conveyed to the discharge tray 22.

After processing S26, the controller 100 determines whether the next page exists or not (S27). If the next page exists in the print job (S27: YES), the controller 100 returns to process S22, and if the next page does not exist in the print job (S27: NO), the controller 100 terminates the flow depicted in FIG. 11.

The printing apparatus 1 of the third embodiment described above also has the same effects as the first embodiment. In particular, since the controller 100 executes the printing process (S25) after the cutting process (S23), it can be suppressed that the printed image is shifted due to execution of the cutting process during execution of the printing process.

### FOURTH EMBODIMENT

Next, the printing apparatus 1 in the fourth embodiment of the present disclosure will be described with reference to FIGS. 16 and 17. For convenience of explanation, members that have the same functions as those described in the first embodiment are marked with the same reference numerals, and the description will not be repeated. In the fourth embodiment of the printing apparatus 1, the flow of control during printing by the controller 100 differs from the first embodiment. In the fourth embodiment, after printing on the first half portion of the sheet P, the sheet P is cut and printing is performed on the second sheet P2 generated after cutting.

As depicted in FIG. 16, when controller 100 receives a print job via communication I/F 109 (S31: YES), the controller 100 executes a conveyance process (S32).

In process S32, the controller 100 rotates the feeding roller 32. As a result, the sheet P is conveyed from the feed tray 21 to the conveyance route R. Further, the controller 100 rotates the roller 50, the resistance roller 52, the roller 54, and the discharge roller 56 in the forward direction. As a result, the sheet P is conveyed to the printer section 4.

After processing S32, the controller 100 controls the printer section 4 to execute a first printing process that prints images from the front end of the sheet P to the center position CL (see FIG. 10) in the conveyance direction, that is, the first half of the sheet P (S33).

After processing S33, the controller 100 executes a reverse conveyance process (S34). In the reverse conveyance process, the controller 100 conveys the sheet P with the image printed on the first half portion to the cutting position C in the reverse direction from the conveyance direction. Specifically, the controller 100 reverses the roller 50, the resistance roller 52, the roller 54, and the discharge roller 56. As a result, the sheet P is conveyed in the reverse direction from the conveyance direction so that the center position CL of the sheet P overlaps the cutting position C.

After processing S34, the controller 100 controls the cutter unit 6 to execute a cutting process to cut the sheet P with the image printed on the first half portion (S35). This produces a first sheet P1 with a printed image and a second sheet P2 without a printed image.

After processing S35, the controller 100 controls the printer section 4 to execute a second printing process (S36) to print an image on the second sheet P2 on which no image is printed as depicted in FIG. 17. Then, the controller 100 executes a discharge process (S37). In the discharge process, the controller 100 rotates the roller 50, the resistance roller 52, the roller 54, and the discharge roller 56 forward. As a result, the first sheet P1 and the second sheet P2 with printed images are conveyed to the discharge tray 22.

After processing S37, the controller 100 determines whether a next page exists or not (S38). If the next page exists in the print job (S38: YES), the controller 100 returns to the process S32, and if the next page does not exist in the print job (S38: NO), the controller 100 terminates the flow depicted in FIG. 16.

The printing apparatus 1 of the fourth embodiment described above also has the same effects as the first embodiment. In particular, the controller 100 executes printing on the first half portion of the sheet P (S33) and printing on the second half portion of the sheet P (S36) separately. This suppresses the shifting of the printed image. When printing on the second half portion of sheet P is not required, a blank second sheet P2 is discharged to the discharge tray 22. This makes it possible to use the blank second sheet P2.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

[Modifications]

In the printing apparatus 1 of the first through fourth embodiments described above, the opening 15 is formed in the upper wall 12 of the housing 10, as depicted in FIG. 2. However, the present disclosure is not limited to these aspects. For example, the opening may be formed in the front wall 11 of the housing 10. The openings may be formed from the front wall 11 to the upper wall 12 of the housing 10.

In the first through fourth embodiments, the length A in the up-down direction between the wall with the opening 15 in the housing 10 and the upper-end of the head carriage 40 is shorter than the length H in the up-down direction and the length D in the front-rear direction of the cartridge 142 mounted in the mounting section 140. However, the present disclosure is not limited to these aspects.

For example, the length A in the up-down direction may be shorter than the length W in the left-right direction of the cartridge 142 depicted in FIGS. 3 and 5. In other words, the length A in the up-down direction may be shorter than any of the length H in the up-down direction, the length D in the front-rear direction, and the length W in the left-right direction of the cartridge 142 mounted in the mounting section 140.

The length A in the up-down direction may be shorter than at least one of the length H in the up-down direction, the length D in the front-rear direction, and the length W in the left-right direction of the cartridge 142.

In the first through fourth embodiments, as depicted in FIG. 6, the external shape of the opening 15 and the head carriage 40 is rectangular in the top view of the printing apparatus 1. The present disclosure is not limited to these aspects. For example, as depicted in FIG. 18, the external shape of the opening 15A and the head carriage 40A may be an abbreviated L-shape in the top view of the printing apparatus 1.

In this case, when head carriage 40A is in the replacement position X, the length B1 between the end of opening 15A on the rear side of housing 10 and the upper-end of the rear side of head carriage 40A closest to the end of the opening 15 is shorter than the length H in the up-down direction of the cartridge 142 mounted in mounting section 140.

The lengths B, B1 between the end of the opening 15, 15A and the upper-end of the rear side of the head carriage 40, 40A that is closest to the opening 15, 15A should be at least shorter than the length D in the front-rear direction of the cartridge 142, and preferably shorter than the length H in the up-down direction of the cartridge 142. Furthermore, it is more preferable that the lengths B, B1 be shorter than the length Win the left-right direction, i.e., the width direction, of the cartridge 142.

Thus, the length A in the up-down direction and the lengths B, B1 can be smaller than the length H in the up-down direction of the cartridge 142, the length D in the front-rear direction, and the length W in the left-right direction. In this case, no matter how the cartridge 142 is tilted, it can be made difficult for the cartridge 142 to enter toward the cutter unit 6. In other words, it becomes difficult for the user's hand to access the cutter unit 6. Therefore, when the user replaces the cartridge 142, the user's hand can be prevented from contacting the cutter unit 6, or the cartridge 142 can be prevented from contacting the cutter unit 6.

In the first through fourth embodiments, the cutter unit 6 cut the sheet P in half. The present disclosure is not limited to such an arrangement. For example, the cutter unit 6 may cut the sheet P into thirds. The position in the front-rear direction at which the sheet P is cut can be changed as needed.

In the first through fourth embodiments, the printing apparatus 1 is a serial printing apparatus that performs printing while moving the head carriage 40 in the scanning direction. The present disclosure is not limited to such an arrangement. The printing apparatus 1 may, for example, be a line-type printing apparatus in which the recording head 41 is fixed relative to the housing 10 and extends over the entire length of the sheet P in the scanning direction, that is, the width direction of the sheet P.

In the first through fourth embodiments, the printing apparatus 1 conveys the sheet P by using roller members (the roller 50, the resistance roller 52, the roller 54, and the discharge roller 56). The present disclosure is not limited to such an arrangement. For example, a belt member may be used to convey the sheet P, or a drum member may be used to convey the sheet P.

The present disclosure may be realized also in the following aspect.

The printing apparatus may further include a conveyance roller located between the head carriage and the processing unit in the conveyance direction and configured to convey the print medium.

According to the above configuration, the processing unit is located upstream of the conveyance rollers in the conveyance direction of the print medium, which ensures that the user's hands do not come into contact with the processing unit when the user replaces the cartridge.

The opening may be located in an upper wall of the housing or in a front wall of the housing that is located upstream in the conveyance direction.

According to the above configuration, an opening is formed in the upper or front wall of the housing so that the user can easily replace the cartridge.

The opening may be located in the upper wall of the housing. The head carriage may be located in the housing with being exposed through the opening. The processing unit may be located in the housing without being exposed through the opening.

According to the above configuration, the processing unit is not exposed through the opening, making it difficult for the user's hand to come into contact with the processing unit.

The printing apparatus may include an open/close portion configured to move between a first position at which the opening is covered and a second position at which the opening is opened; and a shield configured to shield at least a portion of the processing unit from an outside of the housing in a case that the open/close portion is located in the second position. The shield may shield at least a portion of the processing unit from the outside of the housing in a case that the open/close portion is located in the second position.

According to the above configuration, when the opening/closing portion is in the second position to open the opening, a shield is provided to shield at least part of the processing unit from the outside of the housing, thus preventing the user's hand from coming into contact with the processing unit.

The head carriage may be configured to move in a scanning direction orthogonal to the conveyance direction and move to a replacement position in the scanning direction. The processing unit may be located in a standby position, which is displaced in the scanning direction relative to the replacement position, in a case that the cartridge is attached or detached.

According to the above configuration, the replacement position of the head carriage and the standby position of the processing unit are offset in the scanning direction, which prevents the user's hand from coming into contact with the processing unit when attaching or detaching the cartridge.

A length in an up-down direction between the wall of the housing with the opening and an upper-end of the head carriage may be shorter than a length in the up-down direction of the cartridge mounted in the mounting section.

According to the above configuration, it can be difficult to put the cartridge between the wall surface where the opening is formed in the housing and the head carriage, thus preventing the user's hand from coming into contact with the processing unit and the cartridge from coming into contact with the processing unit when the cartridge is replaced.

A length in an up-down direction between the wall of the housing with the opening and an upper-end of the head carriage may be shorter than a length in a front-rear direction, which is the conveyance direction, of the cartridge mounted in the mounting section.

According to the above configuration, it can be difficult to put the cartridge between the wall surface where the opening is formed in the housing and the head carriage, thus preventing the user's hand from coming into contact with the processing unit and the cartridge from coming into contact with the processing unit when the cartridge is replaced.

A length in an up-down direction between the wall of the housing with the opening and an upper-end of the head carriage may be shorter than a length, in a left-right direction perpendicular to the conveyance direction, of the cartridge mounted in the mounting section.

According to the above configuration, it can be difficult to put the cartridge between the wall surface where the opening is formed in the housing and the head carriage, thus preventing the user's hand from coming into contact with the processing unit and the cartridge from coming into contact with the processing unit when the cartridge is replaced.

The length in the up-down direction between the wall of the housing with the opening and the upper-end of the head carriage may be shorter than the length in the up-down direction of the cartridge mounted in the mounting section, a length in a front-rear direction, which is the conveyance direction, of the cartridge mounted in the mounting section and a length in the left-right direction, which is orthogonal to the conveyance direction, of the cartridge mounted in the mounting section.

According to the above configuration, the length in the up-down direction between the wall surface where the housing opening is formed and the upper-end of the head carriage is shorter than the length of the cartridge mounted in the mounting section in the up-down direction, front-rear direction, or left-right direction, making it more difficult to insert the cartridge between the housing and the head carriage.

This ensures that the user's hand does not come in contact with the processing unit and the cartridge does not come in contact with the processing unit when replacing the cartridge.

In a case that the head carriage is located in the replacement position, a length between an end of the opening on a rear side of the housing in a front-rear direction parallel to the conveyance direction, and an upper-end of the head carriage on a rear side of the housing in the front-rear direction at a distance closest to the end of the opening may be shorter than a length in the up-down direction of the cartridge mounted in the mounting section.

According to the above configuration, when the head carriage is in the replacement position, it can be difficult to put the cartridge in the gap between the end of the opening at the rear side of the housing and the upper-end at the rear side of the head carriage, thus preventing the user's hand from contacting the processing unit during cartridge replacement.

The printing apparatus may further include a printer section, a conveyor, a discharge section and a controller. The printer section may include the mounting section, the head, and the head carriage and configured to print an image on the print medium. The conveyor may be configured to convey the print medium. The print medium with the image printed by the printer section may be discharged to the discharge section. The controller may be configured to: control the conveyor to convey the print medium in the conveyance direction to the printer section; control the printer section to print an image from a front edge of the print medium to a first position in the conveyance direction; generate a first print medium and a second print medium by processing the print medium with the image printed from the front edge up to the first position by the processing unit; control the printer section to print an image on the first print medium and the second print medium; and control the conveyor to convey the first print medium and the second print medium with the image printed to the discharge section.

According to the above configuration, the controller performs processing process before printing on the print medium is completed, so processing process can be performed without having the print medium conveyed in the reverse direction from the conveyance direction in a configuration where the processing unit is located upstream in the conveyance direction from the printer section. This reduces the processing time by the controller.

The printing apparatus may further include a printer section, a conveyor, a discharge section and a controller. The printer section may include the mounting section, the head, and the head carriage and configured to print an image on the print medium. The conveyor may be configured to convey the print medium. The print medium with the image printed by the printer section may be discharged to the discharge section. The controller may be configured to: control the conveyor to convey the print medium in the conveyance direction to the printer section; control the printer section to print an image on the print medium; control the conveyor to convey the print medium with the image printed to a processing position in a reverse direction from the conveyance direction; control the processing unit to generate a first print medium and a second print medium by processing the print medium conveyed to the processing position; and control the conveyor to convey the first print medium and the second print medium to the discharge section.

According to the above configuration, the controller executes the processing process after all printing processes are completed, thus preventing the images to be printed from being shifted.

The printing apparatus may further include a printer section, a conveyor, a discharge section and a controller. The printer section may include the mounting section, the head, and the head carriage and configured to print an image on the print medium. The conveyor may be configured to convey the print medium. The print medium with the image printed by the printer section may be discharged to the discharge section. The controller may be configured to: control the conveyor to convey the print medium in the conveyance direction to a processing position; control the processing unit to generate a first print medium and a second print medium by processing the print medium conveyed to the processing position; control the conveyor to convey the first print medium and the second print medium to the printer section in a reverse direction from the conveyance direction; control the printer section to print an image on the first print medium and the second print medium; and control the conveyor to convey the first print medium and the second print medium with the image printed to the discharge section.

According to the above configuration, the controller executes the printing process after the processing process, thus preventing the images printed on the print media from being misaligned.

The printing apparatus may further include a printer section, a conveyor, a discharge section and a controller. The printer section may include the mounting section, the head, and the head carriage and configured to print an image on the print medium. The conveyor may be configured to convey the print medium. The print medium with the image printed by the printer section may be discharged to the discharge section. The controller may be configured to: control the conveyor to convey the print medium in the conveyance direction to the printer section; control the printer section to print an image from a front edge of the print medium to a first position in the conveyance direction; control the conveyor to convey the print medium with the image printed up to the first position in a reverse direction from the conveyance direction to the processing position; control the processing unit to generate a first print medium and a second print medium by processing the print medium in the first position with the image printed up to the first position; control the printer section to print an image on the second print medium; and control the conveyor to convey the first print medium and the second print medium to the discharge section.

According to the above configuration, the controller separately executes printing on the first half of the print media and printing on the second sheet, which is printing on the second half of the media, thereby preventing the images to be printed from being shifted.

What is claimed is:

1. A printing apparatus comprising:
a housing including a wall with an opening;
a mounting section configured to allow a cartridge to be mounted through the opening;
a head with a nozzle to eject a liquid;
a processing unit including a processing section configured to process a print medium; and
a head carriage holding the mounting section and the head, wherein
the processing unit is located upstream of the head carriage in a conveyance direction of the print medium, the conveyance direction being a direction in which the print medium passes while facing the head.

2. The printing apparatus according to claim 1 further comprising a conveyance roller located between the head carriage and the processing unit in the conveyance direction and configured to convey the print medium.

3. The printing apparatus according to claim 1, wherein
the opening is located in an upper wall of the housing or in a front wall of the housing that is located upstream in the conveyance direction.

4. The printing apparatus according to claim 3, wherein
the opening is located in the upper wall of the housing,
the head carriage is located in the housing with being exposed through the opening, and
the processing unit is located in the housing without being exposed through the opening.

5. The printing apparatus according to claim 3, further comprising:
an open/close portion configured to move between a first position at which the opening is covered and a second position at which the opening is opened; and
a shield configured to shield at least a portion of the processing unit from an outside of the housing in a case that the open/close portion is located in the second position, wherein
the shield shields at least a portion of the processing unit from the outside of the housing in a case that the open/close portion is located in the second position.

6. The printing apparatus according to claim 1, wherein
the head carriage is configured to move in a scanning direction orthogonal to the conveyance direction and move to a replacement position in the scanning direction, and
the processing unit is located in a standby position, which is displaced in the scanning direction relative to the replacement position, in a case that the cartridge is attached or detached.

7. The printing apparatus according to claim 1, wherein
a length in an up-down direction between the wall of the housing with the opening and an upper-end of the head carriage is shorter than a length in the up-down direction of the cartridge mounted in the mounting section.

8. The printing apparatus according to claim 1, wherein
a length in an up-down direction between the wall of the housing with the opening and an upper-end of the head carriage is shorter than a length in a front-rear direction, which is the conveyance direction, of the cartridge mounted in the mounting section.

9. The printing apparatus according to claim 1, wherein
a length in an up-down direction between the wall of the housing with the opening and an upper-end of the head carriage is shorter than a length, in a left-right direction perpendicular to the conveyance direction, of the cartridge mounted in the mounting section.

10. The printing apparatus according to claim 7, wherein
the length in the up-down direction between the wall of the housing with the opening and the upper-end of the head carriage is shorter than the length in the up-down direction of the cartridge mounted in the mounting section, a length in a front-rear direction, which is the conveyance direction, of the cartridge mounted in the mounting section and a length in the left-right direction, which is orthogonal to the conveyance direction, of the cartridge mounted in the mounting section.

11. The printing apparatus according to claim 6, wherein
in a case that the head carriage is located in the replacement position, a length between an end of the opening on a rear side of the housing in a front-rear direction parallel to the conveyance direction, and an upper-end of the head carriage on a rear side of the housing in the front-rear direction at a distance closest to the end of the opening is shorter than a length in the up-down direction of the cartridge mounted in the mounting section.

12. The printing apparatus according to claim 1 further comprising:
a printer section including the mounting section, the head, and the head carriage and configured to print an image on the print medium;
a conveyor configured to convey the print medium;
a discharge section to which the print medium with the image printed by the printer section is discharged; and
a controller configured to:
control the conveyor to convey the print medium in the conveyance direction to the printer section;
control the printer section to print an image from a front edge of the print medium to a first position in the conveyance direction;
generate a first print medium and a second print medium by processing the print medium with the image printed from the front edge up to the first position by the processing unit;
control the printer section to print an image on the first print medium and the second print medium; and
control the conveyor to convey the first print medium and the second print medium with the image printed to the discharge section.

13. The printing apparatus according to claim 1, further comprising:
a printer section including the mounting section, the head, and the head carriage and configured to print an image on the print medium;
a conveyor configured to convey the print medium;
a discharge section to which the print medium with the image printed by the printer section is discharged; and
a controller configured to:
control the conveyor to convey the print medium in the conveyance direction to the printer section;
control the printer section to print an image on the print medium;
control the conveyor to convey the print medium with the image printed to a processing position in a reverse direction from the conveyance direction;
control the processing unit to generate a first print medium and a second print medium by processing the print medium conveyed to the processing position; and
control the conveyor to convey the first print medium and the second print medium to the discharge section.

14. The printing apparatus according to claim 1, further comprising:
a printer section including the mounting section, the head, and the head carriage and configured to print an image on the print medium;
a conveyor configured to convey the print medium;
a discharge section to which the print medium with the image printed by the printer section is discharged; and
a controller configured to:
control the conveyor to convey the print medium in the conveyance direction to a processing position;
control the processing unit to generate a first print medium and a second print medium by processing the print medium conveyed to the processing position;
control the conveyor to convey the first print medium and the second print medium to the printer section in a reverse direction from the conveyance direction;
control the printer section to print an image on the first print medium and the second print medium; and
control the conveyor to convey the first print medium and the second print medium with the image printed to the discharge section.

15. The printing apparatus according to claim 1, further comprising:
a printer section including the mounting section, the head, and the head carriage and configured to print an image on the print medium;
a conveyor configured to convey the print medium;
a discharge section to which the print medium with the image printed by the printer section is discharged; and
a controller configured to:
control the conveyor to convey the print medium in the conveyance direction to the printer section;
control the printer section to print an image from a front edge of the print medium to a first position in the conveyance direction;
control the conveyor to convey the print medium with the image printed up to the first position in a reverse direction from the conveyance direction to the processing position;
control the processing unit to generate a first print medium and a second print medium by processing the print medium in the first position with the image printed up to the first position;
control the printer section to print an image on the second print medium; and
control the conveyor to convey the first print medium and the second print medium to the discharge section.
